(19) United States
(12) Patent Application Publication
(10) Pub. No.: US 2023/0015842 A1
(43) Pub. Date: Jan. 19, 2023

(54) Combined Patient Handling and Surgical Positioning System for Use with Mechanical LIfts in the Operating Room

(71) Applicant: David J. Gomez, Holly Springs, NC (US)

(72) Inventor: David J. Gomez, Holly Springs, NC (US)

(21) Appl. No.: 17/871,419

(22) Filed: Jul. 22, 2022

Related U.S. Application Data
(63) Continuation-in-part of application No. 17/083,725, filed on Oct. 29, 2020.
Application No. 17/083,725 is a continuation-in-part of application No. 16/899,796, filed on Jun. 12, 2020, now Pat. No. 11,224,550.
Application No. 16/899,796 is a division of application No. 15/437,017, filed on Feb. 20, 2017, now Pat. No. 10,709,626.
(60) Provisional application No. 63/224,620, filed on Jul. 22, 2021.
(60) Provisional application No. 63/075,276, filed on Sep. 7, 2020.
(60) Provisional application No. 62/927,177, filed on Oct. 29, 2019.
(60) Provisional application No. 62/296,863, filed on Feb. 18, 2016.
(60) Provisional application No. 62/409,578, filed on Oct. 18, 2016.

(51) Int. Cl. A61G 7/10; A61G 13/12

(52) U.S. Cl. CPC A61G 7/1023; A61G 7/1026; A61G 7/1073; A61G 13/1295; A61G 2210/90

(57) ABSTRACT

The present invention provides a combined patient handling and surgical positioning system for use with a mechanical lift for positioning a patient on a surgical table. A pad assembly has a base with a top surface. The base has a plurality of handles attached thereto. The handles have openings defined therein. A foam top is fixedly mounted to the top surface of the base. At least one strap is attached to the pad assembly. The pad assembly is configured to prevent bunching when lifting or repositioning the patient during surgical table positioning changes required during surgery and the pad assembly is configured for movement in multiple directions during surgery. An elongate support member is configured to extend through the openings in the plurality of handles on the pad assembly. A plurality of lifting slings are configured to removably attach to the elongate support bar to the mechanical lift in a surgical theater.

### CROSS-REFERENCE TO RELATED APPLICATION

The present application claims priority benefit of U.S. Provisional Patent Application No. 63/224,620 filed Jul. 22, 2021, entitled “A Modular Surgical Positioning System for Trendelenburg for Use With Mechanical Lifts in the Operating Room,” which is hereby incorporated by reference.

### TECHNICAL FIELD

The present invention relates generally to the field of medical devices for use in the surgical theater, and more particularly to a system for use with a mechanical lift and for securing a patient in a surgical position on a surgical table to include both in-station movements on the same surface of the operating room and from surface to surface from the patient stretcher or in-patient bed to the surgical table prior to operation, and to the same surface after surgery.

### BACKGROUND OF THE INVENTION

One problem with existing pad or gel based systems is that once they are secured to bed rails, the existing systems are not easily moveable, especially when under the weight of the patient. They are fixed in their location once secured. This configuration limits ease of movement of the patient to an optimal surgical position once the patient is settled into the pad system and secured. Due to the lack of easy and ergonomic movement of patients placed upon these fixed surfaces, providers are routinely forced to place the patient in a less than optimal position for anesthesia airway access needed for direct laryngoscopy, which is a necessary requirement for general anesthesia. Providers either place short patients more proximal to them for optimal airway access, or place patients farther down the table away from them, to minimize the repetitive lifting of patients under general anesthesia.

Because most pads are fixed and secured via hook and loop fastener straps, providers must physically and bodily lift the patient off of the semi adhesive pad/gel systems in order to move the patient into the correct bed position required for surgery. This is typically performed via the “cloth-like” draw sheet, which is also used to facilitate arm adduction. The draw sheet included in many viscoelastic foam packs is made of a paper/cloth like material and often lacks full strength to facilitate movement of the patient by providers when positioning changes are required. The providers must routinely grab bodily portions of the patient's torso in contact with the pad in order to move the patient down. It is fairly common in practice to see the pad move or bundle under the patient as larger patients cannot be fully elevated off of the pad thereby dragging the pad with the patient. This foam or gel bundling can lead to pressure points that may lead to injury (e.g., pressure-related skin injuries).

Another issue with viscoelastic or memory foam is that the temperature at which a memory foam retains its properties is limited. If it is too cold, the memory foam will harden.

Routine movement and methodologies for moving patients on these pad/gel based systems begin to fail, especially during the care of moderate to morbidly obese patients. Rising obesity rates in the United States also place significant ergonomic safety and injury risks to health care providers as they must routinely physically lift and move these patients in order to facilitate certain surgical procedures. The healthcare industry faces a problem with a lack of products focused on improving methodologies and practices that facilitate less variance and safe care strategies, i.e., process improvements required for surgical positioning. The industry also lacks products designed to provide safer and more ergonomic processes for moving patients, which can be a key contributor to musculoskeletal disorders (MSD) and injuries (especially involving the back) suffered by providers.

What is needed is a modular pad assembly and system that overcomes the shortcomings described above and is capable of engaging with a mechanical lift in an operating room, thereby combining patient transfer processes with precise surgical positioning patient handling processes for specialized surgical procedures.

### BRIEF SUMMARY OF THE INVENTION

The present invention meets the above described need by providing a surgical positioning system (20) for use with a mechanical lift for positioning a patient on a surgical table. The system includes a pad assembly (23) having a foam top (35) with a top surface (26).

The foam top (35) is attached to a base (38) that has a plurality of handles (29) attached thereto. The handles (29) have openings (41) defined therein.

The foam top (35) is fixedly mounted to the top surface (26) of the base (38). At least one strap (32) may be attached to the pad assembly (23). The pad assembly (23) is configured to prevent bunching when lifting or repositioning the patient during surgical table positioning changes required during surgery. Also, the pad assembly (23) is configured for movement in multiple directions during surgery.

The system (20) includes at least one elongate support member (60) configured to extend through the openings (41) in the plurality of handles (29) on the pad assembly (23).

A plurality of lifting slings (72) may be configured to removably attach to the elongate support bar (60) at a first end (76) and configured to attach to the mechanical lift at a second end (79) disposed opposite from the first end (76).

In one aspect, the foam top (35) comprises a pneumatic foam.

The base (38) may comprise a plurality of layers of a nonwoven material.

A reinforcing support sheet may be disposed between the layers of the base (38). The reinforcing support sheet may comprise a condensed foam or a biodegradable cardboard.

The elongate support bar (60) may comprise at least one finger shaped projection (80), (83), and (86) spring biased to receive and hold the first end (76) of one of the plurality of lifting slings (72) in position relative to the bar (60).

The plurality of lifting slings (72) have a first eye (75) at the first end (76) and have a second eye (78) at the second end (79).

The at least one finger shaped projection comprises a pair of first finger shaped projections (83), (86) disposed in a first direction and a second finger shaped projection (80) extending in a second direction opposite the first direction, the second finger shaped projection (80) disposed between the pair of first finger shaped projections (83), (86).

The foam top (35) may comprise a polyurethane foam having 1.8-6 PCF density with a 24-45 ILD (indentation load deflection).

The strap (32) may further comprise hook and loop fasteners, and the strap (32) may be configured to wrap around a rail on a surgical table.

The system (20) of the present invention improves and optimizes clinical efficacy, time, staff utilization, and safety for both patients and staff. The pad assembly (23) facilitates standardization of care by creating less variance during use, while serving to improve safety for providers during ergonomic weight bearing physical movements routinely required during surgical positioning.

The system (20) of the present invention reduces or eliminates the need to pick the patient off of a viscoelastic/gel-based pad via either the “draw sheet” or awkward manual bodily lifting methodologies conducted by the staff.

Instead, the system (20) of the present invention provides a fully moveable system that moves both pad assembly (23) and patient and even helps transfer the patient to a post-operative stretcher, which also aids ergonomic processes inherent in surgical care.

The pad assembly (23) of the present invention helps improve the ergonomic patient handling and positioning of patients over the standard and historic use of moving patients by hand and lift sheet, especially when caring for obese patients, or those patients with hip fractures. The current embodiment can be placed under the patient when regional anesthesia (spinal, epidural, and combined) is used on the patient stretcher, thus allowing safer ergonomic transfer of patients to the table after regional, sedation, or general anesthesia is performed, as patients cannot be placed on these narrow tables before these anesthesia processes due to the table size, or when the tables accessories are not utilized correctly.

The supportive non-woven structure of the pad assembly (23) of the present invention allows for the device to be anchored onto the table via two methods, a set of bilateral straps (32a, 32b) at the upper end of the pad assembly (23) are secured to the surgical bedrail and either the distal end of the rail structure of the table, or around the narrow angle of specialty tables.

The foam top (35) is made of polyurethane or other types of fast recovery or compressible foam needed to provide some degree of traction and support. The most predominant of these is non “memory foam” or non “viscoelastic” in origin or ingredients. The density is set to provide adequate cushioning needed to reduce pressure injuries, as most current viscoelastic foams “bottom out” when subjected to heavy patient and bony skeletal structures such as the scapula and sacrum, as they are only 1-3 inches on average. The foam is temperature stable and not subject to the “glass transition” or hardening viscosity due to cold operating room environments. It does not impede grounding during cautery and is readily radiolucent.

### BRIEF DESCRIPTION OF THE DRAWINGS

FIG. 1 is a perspective view of one embodiment of the modular surgical positioning system of the present invention.

FIG. 2A is a perspective view of the pad assembly of the present invention.

FIG. 2B is a cutaway view of the base of the pad assembly of the present invention.

FIG. 3 is a top plan view of the pad assembly of the present invention.

FIG. 4 is a top plan view of the system shown in FIG. 1.

FIG. 5 is a bottom plan view of the system show in FIG. 1.

FIG. 6 is a perspective view of a portion of the system shown in FIG. 1.

FIG. 7 is a top plan view of the portion shown in FIG. 6.

FIG. 8 is a bottom plan view of the portion shown in FIG. 6.

FIG. 9 is a perspective view of one embodiment of the elongate support member of the present invention.

FIG. 10 is a side elevation view of the modular surgical positioning system of the present invention.

FIG. 11 is an enlarged perspective view of one end of the elongate support member engaged with an eye of a lifting sling.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

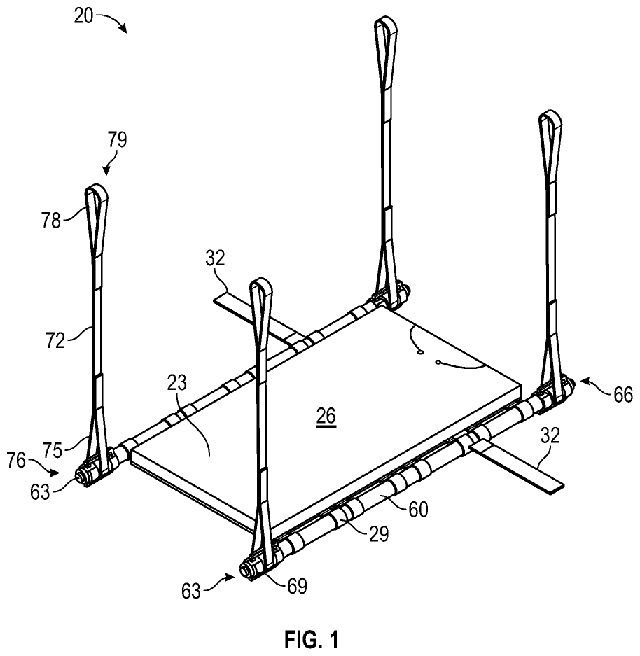

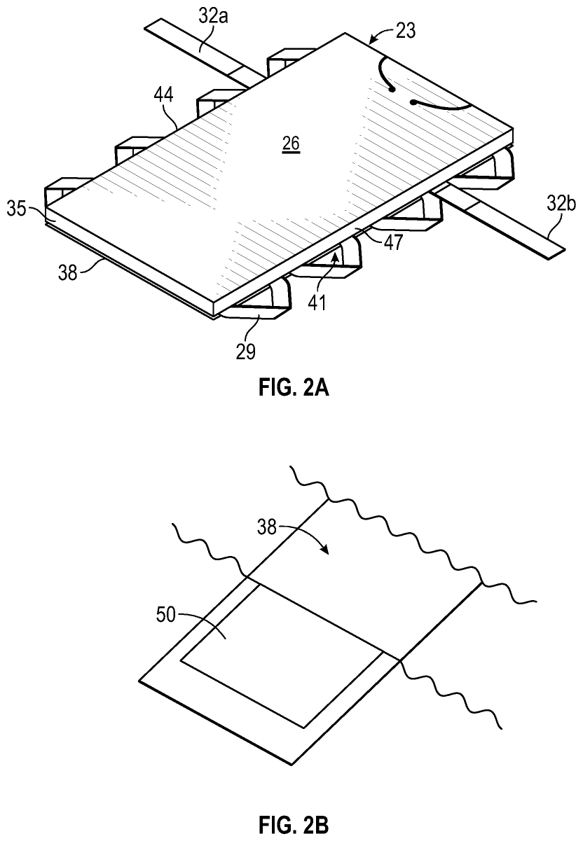

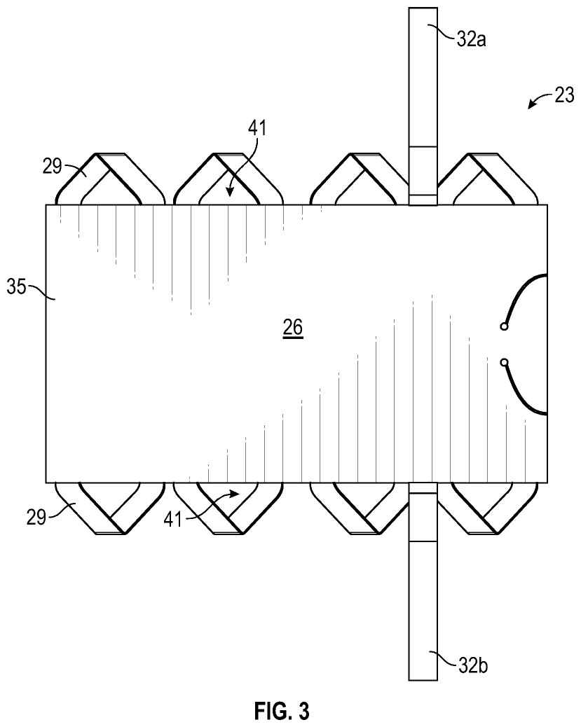

Referring initially to FIG. 1, a surgical positioning system 20 is designed for use with an overhead mechanical lift (not shown). The system 20 includes a pad assembly 23 for supporting a patient during transport to and from a surgical table and for movement of a patient on a surgical table before, after, and during a surgical procedure in a surgical theater. The pad assembly 23 has a top surface 26 that is described in greater detail herein. The pad assembly 23 has a plurality of handles 29 (best shown in FIGS. 2 and 3) extending from opposite sides of the pad assembly 23. The pad assembly 23 also may have straps 32 extending from opposite sides of the pad assembly 23.

Turning to FIGS. 2 and 3, the pad assembly 23 of the present invention is shown in greater detail. The pad assembly 23 may comprise a foam top 35 and a base 38.

The foam top 35 provides a support surface for the patient. The foam top 35 may be constructed of a polyurethane foam referred to as a pneumatic foam. Alternatively, the foam top 35 may be constructed of a combination of pneumatic and standard polyurethane foams. A fast recovery, compressible and resilient foam with a high coefficient of friction may be used. Pneumatic foam having an optimized ILD (indentation load deflection) to restrict “bottoming out” provides resilient rebound needed to protect skin and tissue integrity in cold operating room environments. Most viscoelastic memory foams collapse greater than or equal to 70-98% due to their ILD when patient weight is added, and provide slow rebound due to changes in foam viscosity in cold operating room environments. The foam top 35 of the present invention may comprise a pneumatic foam that is a foam that remains flexible at low temperatures in contrast to memory foam. The foam remains flexible at low temperatures because of its conventional foam chemistry (non-viscoelastic). The foam improves pressure reduction in cooler environments like the operating room and can function without efficacy loss across a temperature gradient of 0 to 100 degrees F. The foam may comprise a polyurethane foam with the following ingredients: polyether, polyol MDI, water, silicone, surfactant, amine, catalyst blue and pigment. The pneumatic foam may be a polyurethane foam available by product number HRJZ12250BUM from Rogers Foam Corporation in Somerville, Mass. The foam may have a density of 2.35-2.65 pounds per cubic foot (PCF). The foam has 25% IFD (15×15×9) of 12-17. Additional properties include: Tensile psl=6 (min.); Elongation %=120 (min); Tear, ppi=0.5 (min); Comfort factor=1.6 (min); Hysteresis %=25 (max); and ball rebound 20-25%.

The base 38 may be made of a sturdy, flexible material. The material may be a nonwoven layered material such as SMS (spun-melt-spun), similar celluloid material, or the like. Other materials include cotton, ripstop nylon, or similar robust synthetic or organic textile material. The plurality of handles 29 extending outward from the sides 44, 47 of the base 38 have openings 41 defined therein. The handles 29 may be formed by loops of material attached to the sides 44,47 of the base 38. The handles 29 are sized to receive the hand of a provider such that a provider on each side of the pad assembly 23 can grasp the handles 29 with their hands in order to move the base 38 along the length of the surgical table to position and re-position the patient as necessary during a surgical procedure. Alternatively, two providers on each side can each grab a handle to move heavier patients. The handles 29 also provide an attachment point for supporting the pad assembly 23 from a mechanical lift as will be described herein.

A reinforcing support sheet 50 may be provided for additional structural support for the pad assembly 23. The reinforcing support sheet 50 may be constructed of a condensed foam or biodegradable cardboard piece that may be inserted between layers of the nonwoven material that comprise the base 38. Alternatively, the reinforcing support sheet 50 may comprise a biodegradable cardboard or cellulose material, or similar flexible soft material form structure.

The foam top 35 may be attached to the base 38 by pressure sensitive adhesive or spray adhesives or any other attachment method as will be evident to those of ordinary skill in the art based on this disclosure. A high friction polyurethane or pneumatic foam top 35 may be joined to the nonwoven base via spray adhesive or pressure sensitive adhesive. All of the adhesives are FDA approved.

The pad assembly 23 with a pneumatic foam top 35 is preferable to foam by itself because the extra support provided by the combination of the base 38 and the foam top 35 prevents the foam from bunching up under the patient when lifting and/or repositioning the patient. It also allows the provider to pull back in case the patient was not positioned correctly. The pad assembly 23 provides structure so that the foam does not elongate, tear, or create laxity during movement of the patient.

A pair of straps 32a and 32b may extend in opposite directions from the pad assembly 23. The straps 32a and 32b may be provided with mating hook and loop fastening surfaces such that the distal end of the straps 32 can be inserted through a bed rail and then secured to the mating hook and loop fastening surface.

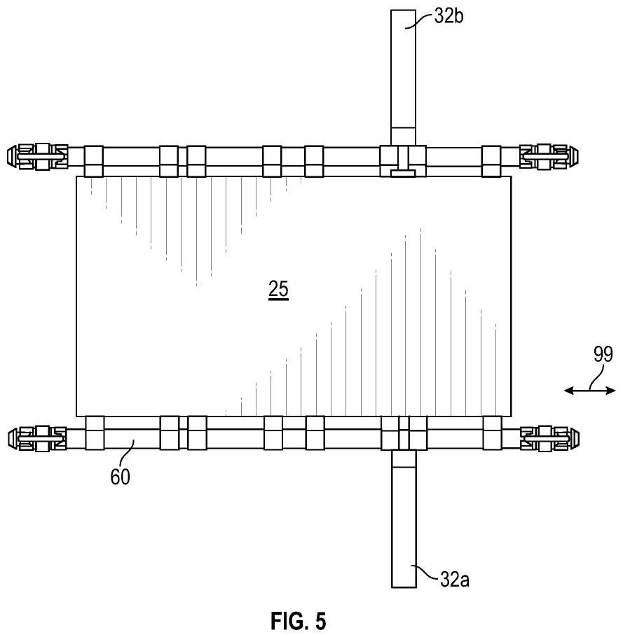

A bottom surface 25 (FIG. 5) of the pad assembly 23 may be provided with a plurality of strips of pressure sensitive adhesive (“PSA”). The PSA strips are configured to engage with the top surface of the surgical table. The PSA is FDA approved, and provides for temporarily securing the pad assembly 23 at different locations on the top surface of the surgical table.

The foam top 35 may be attached, secured or fused to the base 38 by means of pressure sensitive strips. Other means for attaching the foam top 35 to the base 38 such as by sewing, fusing, adhesives or the like may also be used as will be evident to those of ordinary skill in the art based on this disclosure. Another process for attaching the foam top 35 to the base 38 may include use of a spray adhesive. The spray adhesive may be applied across the entire area of the top surface of the base 38.

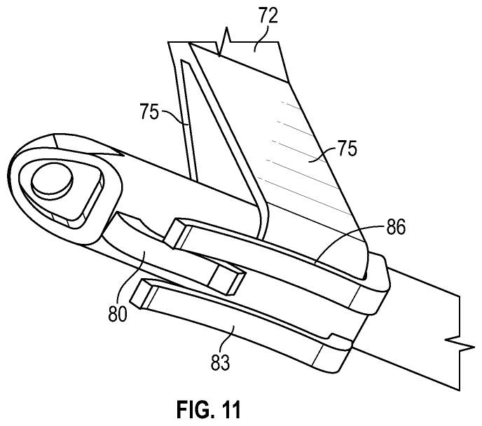

Returning to FIG. 1, an elongate support member 60 may be provided on each side of the pad assembly 23. The elongate support member 60 may be inserted through some or all of the openings 41. At opposite ends 63 and 66 of the elongate support member 60, clips 69 may be provided. The clips 69 which are described in detail herein are one option for removably attaching a lifting sling 72 to the elongate support member 60. The lifting sling 72 may be constructed of any strong, flexible materials suitable for use as a strap for rigging purposes. The lifting slings 72 must be capable of combining with the other lifting slings to support the pad assembly 23, the elongate support members 60, and a patient, with the total weight being between eighty and five hundred pounds. In some extreme cases, the weight may exceed five hundred pounds up to five hundred pounds. The lifting slings 72 may be provided with eyes 75 at a first end 76 and eyes 78 at a second end 79 opposite the first end 76. The eyes 75 may be received by the clips 69 to provide for attaching the lifting slings 72 to the elongate support member 60. As best shown in FIG. 11, the clip 69 at the end of the elongate support member 60 may comprise a plurality of finger-shaped projections 80, 83, and 86. The finger-shaped projections 80, 83 and 86 may be spring biased such that the finger-shaped projections may deflect in one direction under a force and then return to their original position. The end 76 of the lifting sling 72 with the eye 75 may be received in the clip 69 such that it slides past finger shaped projection 80 and then is held in position against the elongate bar by finger-shaped projections 83 and 86.

Returning to FIG. 1, the opposite end 79 of the lifting slings 72 has an opening in an eye 78 that is configured to removably attach to the mechanical lift disposed above the surgical table in the surgical theater.

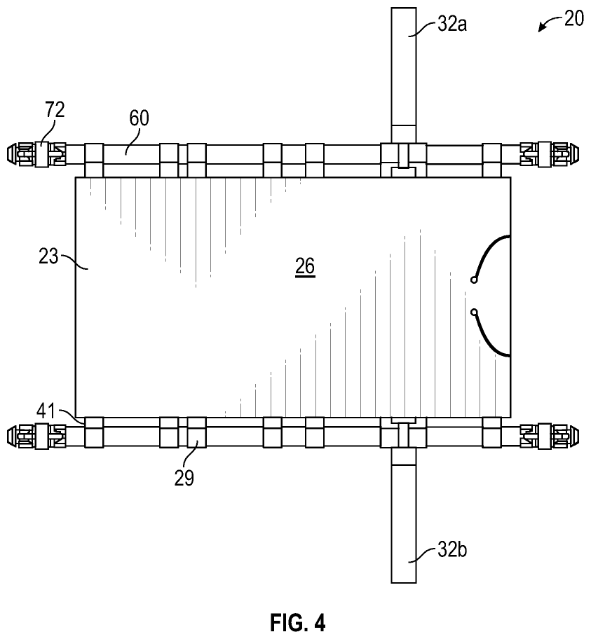

In FIG. 4, a top plan view of the system 20 shows the elongate support member 60 threaded through each of the openings 41 in the handles 29 extending from opposite sides of the pad assembly 23. The lifting slings 72 are attached at each of four corners of the system 20 for better control and weight distribution during lifting of the patient. The straps 32a and 32b may be attached to the rails of the surgical table after the system 20 has been positioned on the surgical table after transport.

In FIG. 5, a bottom plan view of the system 20 is shown. The bottom surface 25 rests on the surgical table after the system 20 has been moved by the overhead mechanical lift in the surgical theater. Once the system 20 is in position and supported on the surgical table and the tension is removed from the mechanical lift system, the elongate support member 60 can be easily slid in the direction of arrows 99 in order to remove it from the system 20. After the elongate member 60 is removed, the straps 32a and 32b can be attached to the rail on the surgical table. Once the elongate member 60 is removed, the pad assembly 23 can be moved manually by gripping the handles 29 or the elongate member 60 can be reinserted and connected to the lifting slings 72 to provide for use of the mechanical lift again.

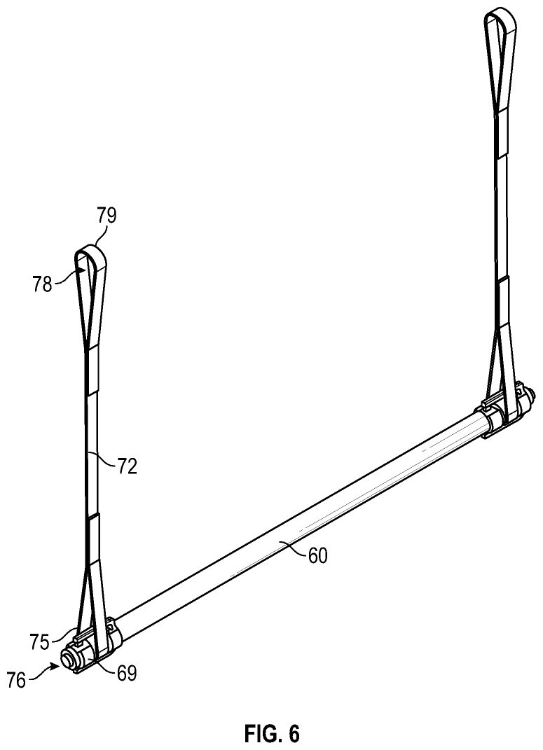

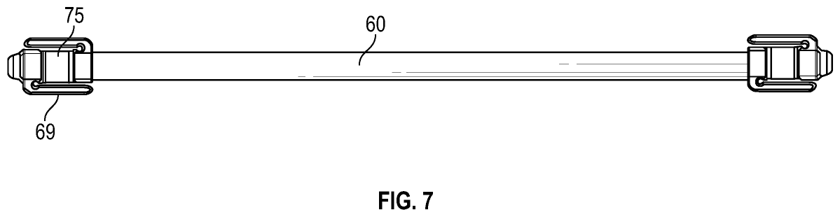

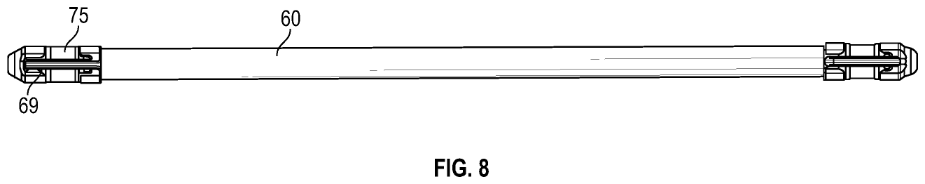

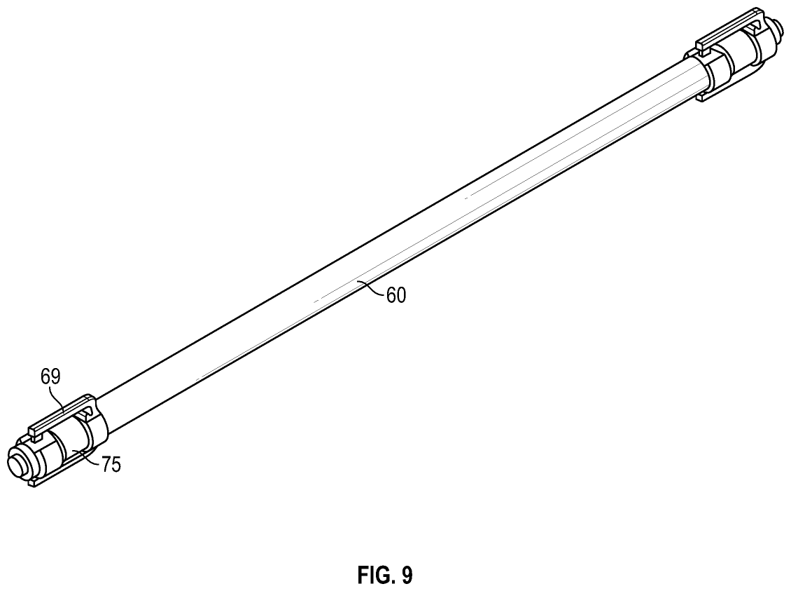

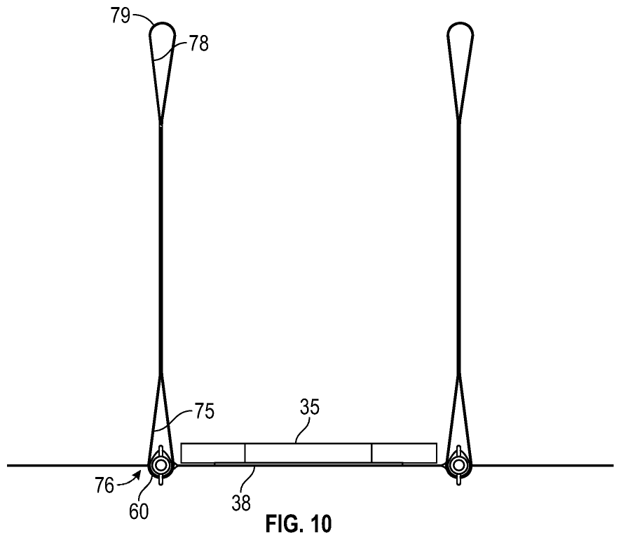

As shown in FIGS. 6-10, the clip 69 on the elongate support member 60 provides for secure attachment of the lifting sling 72. As will be evident to those of ordinary skill in the art based on this disclosure, the lifting sling 72 with two eyes 75, 78 is one structure for connecting the system 20 to a mechanical lift. Other slings, chains, or rigging structures may also be suitable for connecting between the elongate support member 60 and the mechanical lift.

The present invention provides a modular system 20 that utilizes a pad assembly 23 with handles 29 that can be used for manually moving the pad assembly 23 between locations on a surgical table before, during, or after a surgical procedure. The handles 29 are also configured to mate with the elongate support member 60 to provide for use with a mechanical lift system.

The present invention provides many advantages. The present invention provides surgical providers with a pad assembly 23 to be placed under a patient (before or after) performing routine processes such as regional anesthesia (spinal, epidural, or combined/CSE), in either a sitting or lateral position, or (before or after) general anesthesia induction and intubation processes while on the patient's bed or stretcher. The movable friction pad assembly 23 allows staff to safely move a patient onto a surgical table with better ergonomics over traditional sheet and hand lifting. The pad assembly 23 also allows staff to move both patient and pad assembly 23 distal to the apex of the table for surgery.

The present invention provides a modular friction pad assembly 23 made of pneumatic foam that is resilient and provides rebound support required for optimized tissue management. Pneumatic foam is not a “memory foam” and does rely on the indention of patient weight to hold and secure the patient during distraction. It relies on its high friction coefficient to maintain traction and support needed for stability. The foam is not affected to temperature via the “glass transition” typical of memory foams. It does not require the patient's warmth or direct contact to provide pressure support or relief, especially in colder operating room environments. Pneumatic foam does not change viscosity based on temperatures in ranges from 0 degrees Fahrenheit to 100 degrees Fahrenheit.

The present invention also provides a modular friction pad assembly 23, with handles 29, that allows patients to be moved post operatively onto a stretcher or inpatient bed, thereby improving the comfort of patient over moving the patient on a “hard” rolling board. This creates a seamless transition and “log-roll” stability needed for post-operative joint stabilization.

The present invention also provides a modular pneumatic foam friction pad assembly 23 with handles 29 that has a fast recovery of compressible and resilient foam needed to provide a high degree of traction needed for omnidirectional rotation of the surgical table (Trendelenburg, reverse Trendelenburg, lateral rotations) and support at distraction pressures of 5-300 lbs of force pulled via manual or mechanical pulling of the lower extremities. Pneumatic foam has an optimized ILD (indentation load deflection) to restrict “bottoming out”, thus providing resilient rebound needed to protect skin and tissue integrity in cold operating room environments, as most viscoelastic memory foams collapse >70-98% due to their ILD when patient weight is added, and provide slow rebound due to changes in foam viscosity in cold operating room environments.

The present invention provides a modular reinforced pneumatic foam pad assembly 23 with handles 29 that has a high friction coefficient needed to hold patients in place during hip distraction for both hip arthroplasties and arthroscopies and for general surgical procedures that require omnidirectional rotations of the table to facilitate laparotomy and laparoscopic surgical procedures.

The present invention provides a modular reinforced friction pad assembly 23 with non-woven SMS or similar material base structure 38 fused to the friction foam top 35 so the pad assembly 23 does not elongate, tear, or create laxity during movement of the patient. High friction polyurethane or pneumatic foam top 35 may be fused to the “handled” non-woven base 38 via spray adhesive or high quality pressure sensitive adhesive, each made of FDA approved adhesives.

The present invention provides a modular reinforced friction pad assembly 23 that does not require a draw or lift sheet to move or transfer a patient, thereby maximizing pad to skin contact needed for maximum traction and stability. Draw sheets create heavy and poor ergonomic lifting burdens for surgical staff, as they must physically lift patients off high friction surfaces in order to move them effectively. This places providers at risk for ergonomic MSD injuries. The sheet also reduces effective pad to skin contact needed to optimize friction between the patient and the pad.

The foam is a polyurethane foam of 1.8 lb-6 lb density with 24-45 ILD range.

Therefore, while the presently-preferred form of the system for positioning a patient on a surgical table and for use with a mechanical lift has been shown and described, and several modifications and alternatives discussed, persons skilled in this art will readily appreciate that various additional changes and modifications may be made without departing from the spirit of the invention, as defined and differentiated by the following claims.

1. A combined patient handling and surgical positioning system for use with a mechanical lift for positioning a patient on a surgical table, the apparatus comprising:
a pad assembly having a base with a top surface, the base having a plurality of handles attached thereto, the handles having openings defined therein, a foam top fixedly mounted to the top surface of the base, at least one strap attached to the pad assembly, wherein the pad assembly is configured to prevent bunching when lifting or repositioning the patient during surgical table positioning changes required during surgery, the pad assembly configured for movement in multiple directions during surgery;
at least one elongate support member configured to extend through the openings in the plurality of handles on the pad assembly;
a plurality of lifting slings configured to removably attach to the elongate support bar at a first end and configured to attach to the mechanical lift at a second end disposed opposite from the first end such that the system is configured for overhead lifting of the pad assembly and patient by the mechanical lift.

2. The system of claim 1, wherein the foam top comprises a pneumatic foam or combination of pneumatic and standard polyurethane foams.

3. The system of claim 1, wherein the base comprises a plurality of layers of a nonwoven material.

4. The system of claim 3, further comprising a reinforcing support sheet disposed between two of the layers of the base.

5. The system of claim 4, wherein the reinforcing support sheet comprises a condensed foam or a biodegradable cardboard.

6. The system of claim 1, wherein the elongate support bar comprises at least one finger shaped projection spring biased toward the bar to receive and hold the first end of one of the plurality of lifting slings in position relative to the bar.

7. The system of claim 1, wherein the plurality of lifting slings have a first eye at the first end and have a second eye at the second end.

8. The system of claim 6, where the at least one finger shaped projection comprises a pair of first finger shaped projections disposed in a first direction and a second finger shaped projection extending in a second direction opposite the first direction, the second finger shaped projection disposed between the pair of first finger shaped projections.

9. The system of claim 1, wherein the foam comprises a polyurethane foam having 1.8-6 PCF density with a 24-45 ILD (indentation load deflection).

10. The system of claim 1, wherein the strap further comprises hook and loop fasteners.

11. The system of claim 1, wherein the strap is configured to wrap around a bed rail.

12. A combined patient handling and surgical positioning system for use with a mechanical lift for positioning a patient on a surgical table, the apparatus comprising:
a pad assembly having a base with a top surface, the base having a plurality of handles attached thereto, the handles having openings defined therein, a high friction coefficient foam top fixedly mounted to the top surface of the base, at least one strap attached to the pad assembly;
a reinforcing support sheet disposed in the pad assembly;
wherein the base, high friction coefficient foam pad and reinforcing support sheet are configured to prevent bunching when lifting or repositioning the patient during interstation surgical table positioning changes required during surgery, and the pad assembly is configured for movement in multiple directions during surgery;
at least one elongate support member configured to extend through the openings in the plurality of handles on the pad assembly;
a plurality of lifting slings configured to removably attach to the elongate support bar at a first end and configured to attach to the mechanical lift at a second end disposed opposite from the first end.

13. The system of claim 12, wherein the base further comprises a nonwoven material.

14. The system of claim 12, wherein the base further comprises a spun-melt-spun material.

15. The system of claim 12, wherein the reinforcing layer is a foam configured to prevent laxity of the pad and bunching when lifting a patient by hand or with a mechanical lift.

16. The system of claim 12, wherein the reinforcing layer is cardboard.

17. The system of claim 12, wherein the system can be used with a mechanical lift to move a patient from a stretcher or from an in-patient bed or surface and is configured to lift adult weights from 80 to 1,000 pounds.

18. The system of claim 12, wherein the pad assembly further comprises upper and lower wing members to facilitate arm adduction and to support the arms and hands of the patient off of the end of the surgical table when lithotomy is required.
